(19) United States
(12) Patent Application Publication
(10) Pub. No.: US 2014/0346771 A1
(43) Pub. Date: Nov. 27, 2014

(54) ROTATABLE JOINT

(71) Applicant: Donovan S. Thompson, Racine, WI (US)

(72) Inventor: Donovan S. Thompson, Racine, WI (US)

(21) Appl. No.: 14/285,366

(22) Filed: May 22, 2014

Related U.S. Application Data
(60) Provisional application No. 61/826,350, filed on May 22, 2013.

(51) Int. Cl. F16L 27/00

(52) U.S. Cl. CPC F16L 27/00
USPC 285/281

(57) ABSTRACT

This invention provides a rotatable joint for use with piping systems, optionally sanitary piping systems such as those used in food processing, pharmaceutical processing, and the like, essentially anything which enters a living body or otherwise requiring a “clean room” manufacturing environment. The rotatable joint offers a structure which can be cleaned in place without disassembling the joint or the piping system in which the joint is embodied. In the joint, a tube fitting fits into a housing, with a seal therebetween, wherein the gap between the fluid-contacting surfaces of the housing and the tube fitting is of limited dimension, and that gap is filled by a circumferential protruding portion of the seal, such that the area of the gap presents only a very small area for potentially housing residual material when the joint is cleaned in place.

### CROSS REFERENCE TO RELATED APPLICATIONS

This application claims priority as a non-provisional patent application to provisional application Ser. No. 61/826,350 filed May 22, 2013, which provisional application is herein incorporated by reference in its entirety.

### BACKGROUND OF THE INVENTION

This invention relates to rotatable joints for use in process systems which require that sanitary conditions be maintained within piping systems which transfer product from one or more product sources to one or more product destinations. Between such transfers of product, it may be necessary to disconnect such piping system from either or both of the product source most recently used or the product destination most recently used, and to clean the piping system of any residual product left from the most recent transfer. Where a different product is to be transferred, the piping system must be cleaned of any residual product between product transfers.

Some sanitary process systems require fluids to flow from one source through a piping system to multiple destinations or from multiple sources to a single destination or to multiple destinations. Rigid tube or pipe connections typically do not allow the flexibility of delivering such fluid to or from multiple sources or destinations without disconnecting and reconnecting the piping system, without the need for additional tubes/pipes, fittings or directional valves and/or without cleaning the tubes or pipes between transfers to the respective destinations. Such cleaning can become costly and may impede the process, itself, because of a need for disconnection, manual cleaning, and reconnection of the pipes in order to maintain sanitary conditions. Thus, a piping system which accommodates a clean-in-place process is highly desirable.

In some allegedly sanitary process systems, the materials can allow for surfaces which are porous, which thus become potential sites for retention of residual product, or for bacteria growth.

Other allegedly sanitary process systems may contain material which can leach potential deleterious substances into the product.

Some allegedly sanitary process systems contain crevices which cannot be adequately cleaned in place whereby the respective piping systems have to be disassembled and manually cleaned before they can be used again.

Some allegedly sanitary process systems are constructed using materials which are not acceptable as sanitary or not acceptable for use in food-grade, or pharmaceutical-grade, systems and so may not be acceptable for use to transfer products which need to be maintained in such sanitary conditions.

Other process systems may include acceptable materials, but are configured such that such process systems do not allow for cleaning the piping system in place, namely without disassembling the piping system.

Currently there are no known sanitary rotatable joints which allow the user to perform sanitary transfer functions and which allow the user to clean in place the piping system, including one or more rotatable joints, while the piping system is still connected to the process system.

Accordingly, there is a need for a rotatable joint which can rotate while the piping system is generally in place, but wherein at least one of the pipes joined to the rotatable joint can be rotated with respect to at least one other of the pipes joined to the rotatable joint.

There is also a need for such a rotatable joint which can be cleaned in place.

There is further a need for such a rotatable joint which can be cleaned in place and wherein the piping system can subsequently pass any and all requirements for a food-grade, or pharmaceutical grade, sanitary system.

These and other needs are alleviated, or at least attenuated, or partially or completely satisfied, by novel products, systems, and methods of the invention.

### SUMMARY

This invention provides a rotatable joint which is adapted and configured to operate under sanitary process conditions and to be cleaned in place after conclusion of a fluid transfer through such rotatable joint. After conclusion of such fluid transfer, and after having been cleaned in place, a pipe attached to the rotatable joint can be rotated from a first rotary position to a second rotary position relative to a second pipe attached to the rotatable joint without compromising leak proof properties of the joint and without introducing contamination into the joint or into the piping system through the joint. The rotatable joint includes a housing, a tube fitting received into the housing, a housing bearing element providing bearing functionality between the housing and the tube fitting, a cap, a seal providing seal functionality between the housing and the tube fitting, a closure, and a tube fitting bearing element providing bearing functionality between the cap and the tube fitting.

In a first, family of embodiments, the invention comprehends a rotatable joint, comprising a housing, the housing having a first upper portion and a first upper end, a first lower portion and a first lower end, a first outer surface and a first inner surface, the first inner surface of the housing comprising a first fluid-contacting surface, a first inner-facing bearing surface, and a first seal surface; a tube fitting, the tube fitting having a second upper portion and a second upper end, a second lower portion and a second lower end, a second outer surface and a second inner surface, the second inner surface of the tube fitting comprising a second fluid-contacting surface, the second outer surface of the tube fitting comprising a second outer-facing bearing surface, the tube fitting being adapted and configured such that the second lower portion of the tube fitting is received inside the first upper portion of the housing, a second seal surface, which faces the first seal surface of the housing, being defined on the outer surface of the tube fitting, the first and second seal surfaces collectively defining a seal cavity, a flange extending outwardly and away from the second fluid-contacting surface and being spaced from the top of the tube fitting and from the bottom of the tube fitting, the flange having a top bearing surface; a cap extending about the tube fitting, and overlying the top surface of the flange, the cap having an outer surface and an inner surface; bearing structure comprising a first bearing element extending about the tube fitting, the first bearing element being disposed between the outer surface of the tube fitting and a portion of the cap, and bearing on the top bearing surface of the flange, and a second hearing element below the flange and extending about the tube fitting, the second bearing element being disposed between the first inner-facing bearing surface of the housing and the second outer-facing bearing surface of the tube fitting; a seal in the seal cavity; and a closure urging the cap and the housing toward each other, this applying sealing force against the seal in the seal cavity, thereby to provide a leak-proof seal effect between the housing and the tube fitting at the seal cavity while allowing for rotation of the housing and the tube fitting relative to each other.

In some embodiments, the first and second bearing elements being spaced from each other.

In some embodiments, the joint further comprises a top-to-bottom cut extending through the first bearing element and extending from a top of the bearing element to a bottom of the bearing element.

In some embodiments, the housing and the tube fitting each have a circumference, the seal extending about the entirety of the respective circumferences of the housing and the tube fitting.

In some embodiments, the second fluid-contacting surface of the tube fitting extends from the top of the tube fitting to the bottom of the tube fitting.

In some embodiments, the flange is above the seal cavity.

In some embodiments, coefficients of friction of the first and second seal surfaces define amounts of static friction whereby the static friction between one of (i) the seal and the tube fitting, and (ii) the seal and the housing, is greater than the static friction between the other of (iii) the seal and the tube fitting, and (iv) the seal and the housing, such that, when the tube fitting and the housing rotate relative to each other, the seal remains fixed, and rotates with one of the tube fitting and the housing, while moving relative to the other of the tube fitting and the housing.

In some embodiments, the flange has a bottom bearing surface, and wherein, when the closure applies sufficient force that the flange, meets a top surface of the second bearing element, the first bearing element remains spaced from the top of the housing at least until full/final sealing pressure has been applied at the seal.

In some embodiments, when the closure urges the cap and the housing toward each other, a bottom of the second fluid-contacting surface approaches to within about 0.01 inch to about 0.04 inch, optionally about 0.01 inch to about 0.03 inch, optionally about 0.015 inch, of the first fluid-contacting surface.

In some embodiments, the bottom of the second fluid-contacting surface and the top of the first fluid-contacting surface define a small gap therebetween, the seal extending into such small gap such that an inwardly-facing surface of the seal in the gap has a diameter about a circumference of the rotatable joint substantially no greater than the greater of a diameter of the first fluid-contacting surface or a diameter of the second fluid-contacting surface.

In some embodiments, the bottom of the second fluid-contacting surface and the top of the first fluid-contacting surface define a small gap therebetween, the seal being deformed into, and substantially filling, such gap.

In some embodiments, the first fluid-contacting surface has a top and a bottom, further comprising a chamfer, expanding bottom-to-top, limited to an upper one-fourth portion of the first fluid-contacting surface and extending to the top of the first fluid-contacting surface.

In some embodiments, the first bearing element defines a contacting edge having an edge width, and wherein the urging of the cap and the housing toward each other urges the first bearing element into downwardly-directed bearing contact with the tube fitting at or proximate the top bearing surface of said flange, such downwardly-directed bearing contact at or proximate the top bearing surface being limited to essentially a one-dimensional linear contact limited by the width of the contacting edge.

In some embodiments, the seal is disposed between the second bearing element and the first fluid-contacting surface.

In some embodiments, the first fluid-contacting surface has a top, and the seal is adjacent the top of the first fluid-contacting surface.

In some embodiments, the second bearing element interfaces with the first inner-facing bearing surface of the housing and interfaces with the second outer-facing bearing surface of the tube fitting.

In some embodiments, the joint further comprises a leak detection port extending through the housing at a location displaced from the seal and between the seal and the upper end of the housing.

In some embodiments, the first seal surface faces generally downwardly and the second seal surface faces generally upwardly.

In some embodiments, the first and second bearing elements are embodied in a single unitary bearing structure.

In some embodiments, the single unitary bearing structure embodies a cut through the bearing structure and extending from a top of the bearing structure to a bottom of the bearing structure.

In some embodiments, the invention comprehends a piping assembly comprising first and second pipes, joined together by a rotatable joint of as described herein.

In some embodiments, such piping assembly, including the rotatable joint, can be cleaned in place and thereby meet sanitary requirements for use of food-grade product in the piping assembly subsequent to such piping assembly having been cleaned in place.

In some embodiments, the invention comprehends a method of transferring fluid product comprising employing a piping assembly of the invention wherein the piping assembly is cleaned after a such fluid product transfer without separating the rotatable joint from the piping assembly.

In a second family of embodiments, the invention comprehends a rotatable joint, comprising a housing, the housing having a first upper portion and a first upper end, a first lower portion and a first lower end, a first outer surface and a first inner surface, the first inner surface of the housing comprising a first fluid-contacting surface, a first inner-facing bearing surface, and a first seal surface; a tube fitting, the tube fitting having a second upper portion and a second upper end, a second lower portion and a second lower end, a second outer surface and a second inner surface, the second inner surface of the tube fitting comprising a second fluid-contacting surface, the second outer surface of the tube fitting comprising a second outer-facing bearing surface, the tube fitting being adapted and configured such that the second lower portion of the tube fitting is received inside the first upper portion of the housing, a second seal surface, which faces the first seal surface of the housing, being defined on the outer surface of the tube fitting, the first and second seal surfaces collectively defining a seal cavity, a flange extending outwardly and away from the second fluid-contacting surface and being spaced from the top of the tube fitting and from the bottom of the tube fitting, the flange having a top bearing surface; bearing structure extending about the tube fitting, a first portion of the bearing structure bearing on the top surface of the flange, a second portion of the bearing structure being disposed below the flange and extending about the tube fitting, the second portion of the bearing structure being disposed between the first inner-facing bearing surface and the housing and the second outer-facing bearing surface of the tube fitting; a seal in the cavity; and a closure extending about the housing and the tube fitting and overlying a top of the bearing structure over the flange, and urging the tube fitting and the housing toward each other, thus applying sealing force against the seal in the cavity, thereby to provide a leak-proof seal effect between the housing and the tube fitting at the seal cavity while allowing for rotation of the housing and the tube fitting relative to each other.

In some embodiments, the invention further comprises a top-to-bottom cut extending through the bearing structure from a top of the bearing structure to a bottom of the bearing structure.

In some embodiments, the bearing structure interfaces with the first inner-facing surface of said housing and interfaces with the second outer-facing surface of the tube fitting.

### BRIEF DESCRIPTION OF THE DRAWINGS

Illustrative embodiments of the invention are described hereinafter, by way of example only, with reference to the accompanying drawings.

FIG. 1 shows a pictorial view of an assembled rotatable joint of the invention, having a straight connector at the top of the tube fitting.

FIG. 2 is a pictorial exploded view of the rotatable joint of FIG. 1.

FIG. 3 is a cross-section elevation view of a rotatable joint as in FIGS. 1 and 2 with flanges added to the housing and tube fitting.

FIG. 4 is a cross-section of the rotatable joint of FIG. 3, showing the joint assembly before final sealing pressure is applied, with the seal shown on only one side of the rotatable joint.

FIG. 5 is the rotatable joint of FIG. 4, showing the joint assembly after final sealing pressure has been applied.

FIG. 6 shows a portion of a piping system where first and second pipes are joined to each other using a rotatable joint as in FIG. 1.

FIG. 7 shows a cross-section as in FIG. 5, but employing a single unitary bearing structure for the first and second bearing elements.

FIG. 8 shows a cross-section as in FIG. 7 wherein the cap has been merged into the closure.

The invention is not limited in its application to the details of construction, or to the arrangement of the components, or to the methods of construction, set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

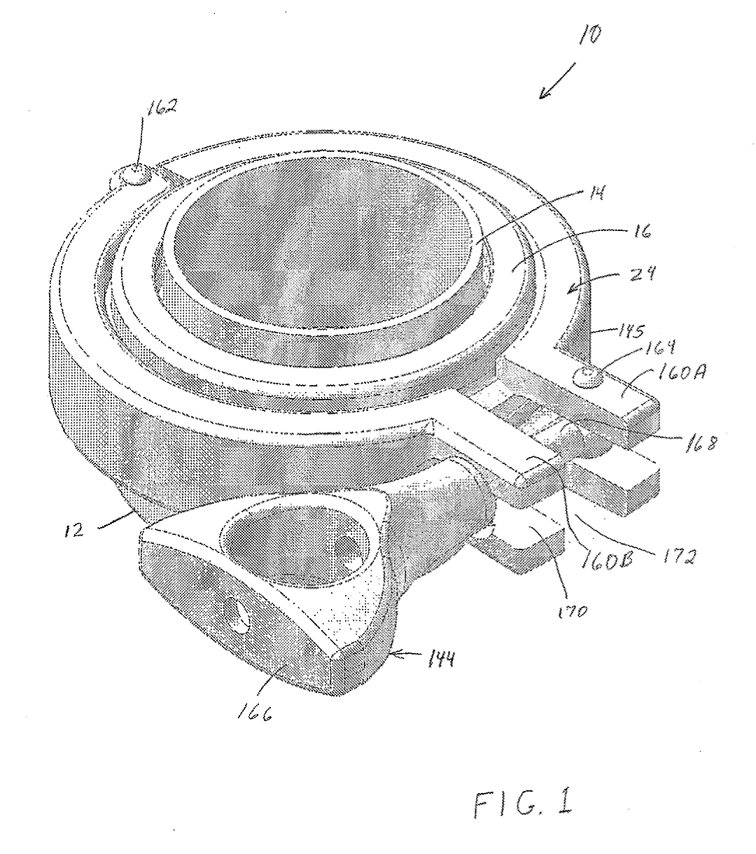

A rotatable joint 10 of the invention, as illustrated in FIGS. 1-4, includes a housing 12, a tube fitting 14, a cap 16, a cap bearing element 18, a housing bearing element 20, a seal 22, and a clamp-type closure 24.

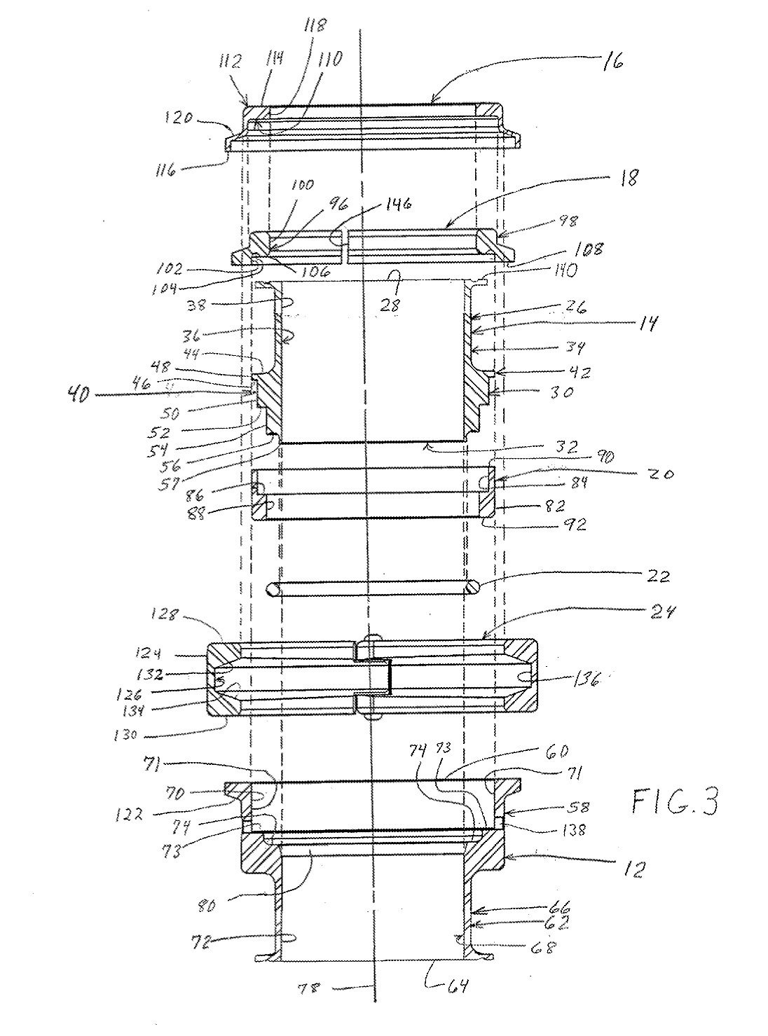

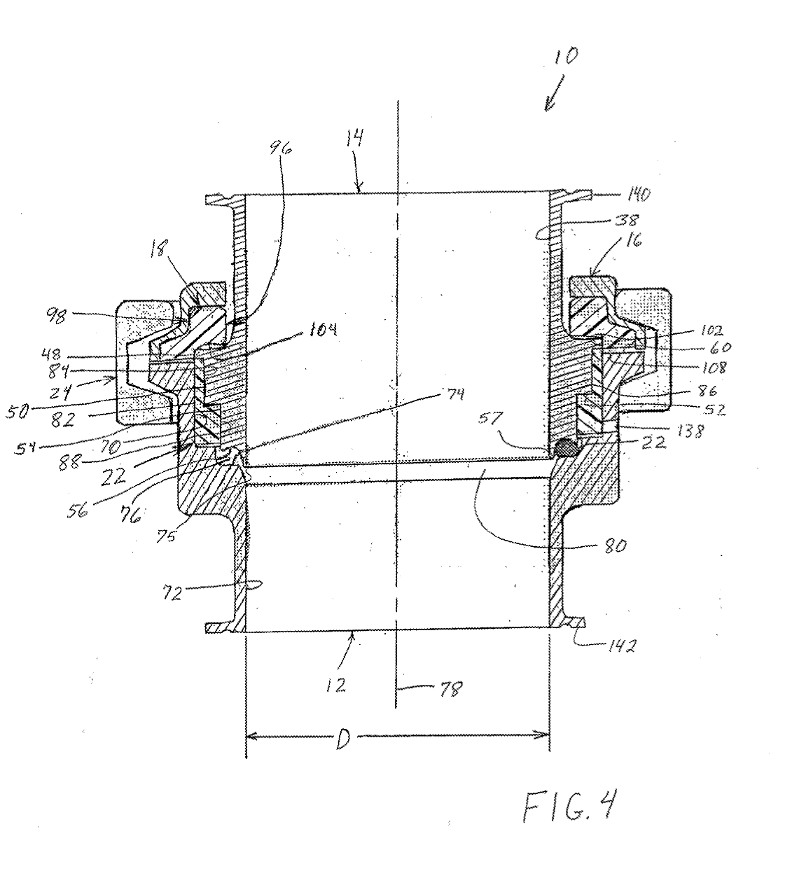

Referring to FIGS. 3 and 4, tube fitting 14 has a generally tubular form, including an outer perimeter, an inner perimeter, and a circumference extending thereabout. Tube fitting 14 has an upper portion 26, an upper end 28 at the top of the tube fitting, a lower portion 30, a lower end 32 at the bottom of the tube fitting, an outer surface 34, and an inner surface 36. Inner surface 36 includes a fluid-contacting surface 38 which extends from the upper end of the tube fitting to the lower end of the tube fitting.

The bottom portion 40 of outer surface 34 of tube fitting 14 which is at lower portion 30 extends generally outwardly from the portion of outer surface 34 which is at upper portion 26. Bottom portion 40 includes an outwardly-extending flange 42, extending in a direction generally perpendicularly away from inner surface 36. Flange 42 has a top surface 44, a bottom surface 46, and an outwardly-directed remote circumferential surface 48.

Outer surface 34 extends downwardly from flange bottom surface 46 at a generally constant diameter along a first lower tube fitting bearing surface 50, to an inward step 52. From inward step 52, outer surface 34 extends downwardly at a generally constant diameter along a second lower tube fitting bearing surface 54 which ends at a seal surface 56 proximate the lower end of the tube fitting. Seal surface 56 is defined by an annular, downwardly-facing recess proximate the lower end of the tube fitting. A downwardly-directed, circumferentially-extending, finger 57 is disposed between a lower portion of fluid-contacting surface 38 of the tube fitting and an inwardly disposed, outwardly-facing, portion of seal surface 56.

Housing 12 has a generally tubular form, including an outer perimeter, an inner perimeter, and a circumference extending thereabout. Housing 12 has an upper portion 58, an upper end 60 at the top of the housing, a lower portion 62, a lower end 64 at the bottom of the housing, an outer surface 66, and an inner surface 68. Both the inner and outer surfaces of housing 12, at upper portion 58, generally extend radially outwardly from the respective inner and outer surfaces of the housing at lower portion 62.

Inner surface 68 includes an inner-facing bearing surface 70 generally coincident with the upper portion of the housing, a fluid-contacting surface 72 generally coincident with the lower portion of the housing, and a housing seal surface 74 located between bearing surface 70 and fluid-contacting surface 72. Bearing surface 70 includes a radial bearing surface element 71 and an axial step bearing surface 73. Seal surface 74 typically borders, or is close to, the top of fluid-contacting surface 72 and step bearing surface element 73 and faces seal surface 56 on the tube fitting. Bearing surfaces 70 and 56 collectively define a seal cavity 76 therebetween as illustrated at the left side of the assembly in FIG. 4.

Lower portion 30 of tube fitting 14 is received in upper portion 58 of housing 12 such that the fluid-contacting surfaces 38 and 72 are generally aligned with each other about a common longitudinal axis 78.

Referring to FIG. 4, starting at lower end 62 of the housing, fluid-contacting surface 72 extends upwardly at a generally constant diameter “D” to a point toward the upper end of fluid-contacting surface 72. Toward the upper end of fluid-contacting surface 72, the fluid-contacting surface is chamfered so as to flare outwardly to the top of the fluid-contacting surface. Chamfer 80 as illustrated represents about 12 percent of the height of fluid-contacting surface 72. Chamfer 80 may occupy as little as about 3 percent, up to about 25 percent, of the height of fluid-contacting surface 72. The angle of chamfer 80 relative to longitudinal axis 78 is typically about 20 degrees, and can vary from about 10 degrees to about 45 degrees.

The purpose of chamfer 80 is to provide a zone of low pressure at the area of seal 22 in order to impede accumulation of residual product or other contaminants at the seal during a product transfer operation, and to facilitate removal of any such residual product or other contaminants during a clean-in-place operation. Accordingly, the height of the chamfer, and angle of the chamfer based on the direction of longitudinal axis 78, depend on the diameter and length of the housing, as well as on the types of product contemplated to be transferred through the rotatable joint and the contemplated transfer pressures.

A further purpose of the chamfer is to provide a circumferentially-extending lateral gap 75 between the top of fluid-contacting surface 72 and finger 57, namely a clearance between housing 12 and transfer fitting 14.

Seal 22 is disposed in seal cavity 76 and is retained in cavity 76 between respective concave seal surfaces 56 and 74. In the illustrated embodiment, seal 22 is a rubber o-ring which extends about the entire annulus of the joint, in cavity 76, both about the annulus of tube fitting 14 and about the annulus of housing 12 at cavity 76. The rubber in seal 22 is food grade or pharmaceutical grade to the extent needed for the amount of contact the seal will have with fluids which are contemplated to be transferred through rotatable joint 10. Seal 22 is sized and configured so as to provide a leak-proof seal between seal surfaces 56 and 74 when tube fitting 14 and housing 12 are urged toward each other by closure 24.

Housing bearing element 20 is disposed in the space between the upper portion of the housing and the lower portion of the tube fitting. Housing bearing element 20 has an outer-facing bearing surface 82, an upper inner-facing bearing surface 84, a step surface 86, a lower inner-facing bearing surface 88, an upper bearing surface 90, and a lower bearing surface 92. Outer-facing bearing surface 82 bears radially on radial bearing surface 70 of the housing. Inner-facing bearing surfaces 84 and 88 bear radially on radial bearing surfaces 50 and 54 of the tube fitting. Step bearing surface 86 can optionally bear axially on step 52 of tube fitting 14. Lower bearing surface 92 faces, and is shown spaced from, step bearing surface 73 of the housing. But bearing surface 92 can bear on surface 73 when the seal is properly seated with suitable pressure from flange 42.

Cap bearing element 18 has a generally annular form, including an outer perimeter, an inner perimeter, and a circumference extending thereabout. Bearing element 18 has an inner surface 96 facing generally toward the upper portion of tube fitting 14, and an outer surface 98 facing generally away from the upper portion of tube fitting 14. Inner surface 96 has an upper upright surface 100 facing the outer surface of the tube fitting, and a lower upright surface 102 facing, and bearing on, remote surface 48 of flange 42. A downwardly-facing surface 104 of bearing element 18 spans the distance between upright surfaces 100 and 102. In the embodiment illustrated, downwardly-facing surface 104 is upwardly concave, spacing surface 104 from top surface 44 of flange 42. Surfaces 100 and 104 define an edge 106 therebetween, having a relatively narrow width which defines a generally one-dimensional line of contact with flange 42 about the annulus of tube fitting 14. A second downwardly-facing surface 108 spans the distance between the inner and outer surfaces at the bottom of bearing element 18. Surface 108 faces, and is spaced from upper end 60 of housing 12; but surface 108 can bear on upper end 60 when the seal is properly seated with suitable pressure from flange 42. Typically, surface 108 contacts upper end 60 and surface 92 contacts surface 73 both at the same time, if at all.

Cap 16 has a generally annular form, including an outer perimeter, an inner perimeter, and a circumference extending thereabout. Cap 16 has an inner surface 110 facing generally toward bearing element 18, an outer surface 112 facing generally away from bearing element 18, a top 114 as part of the outer surface, a bottom surface 116, and an upstanding end surface 118. The configuration of inner surface 110 of cap 16 generally conforms to the configuration of outer surface 98 of cap bearing element 18. The configuration of outer surface 112 generally parallels the configuration of inner surface 110, while providing a generally greater thickness between the inner and outer surfaces at the top 114 of the cap. Bottom surface 116 faces, and is spaced from, upper end 60 of housing 12 but, like surface 108 and surface 92, can contact upper end 60 when the seal is fully seated in preventing fluid leakage.

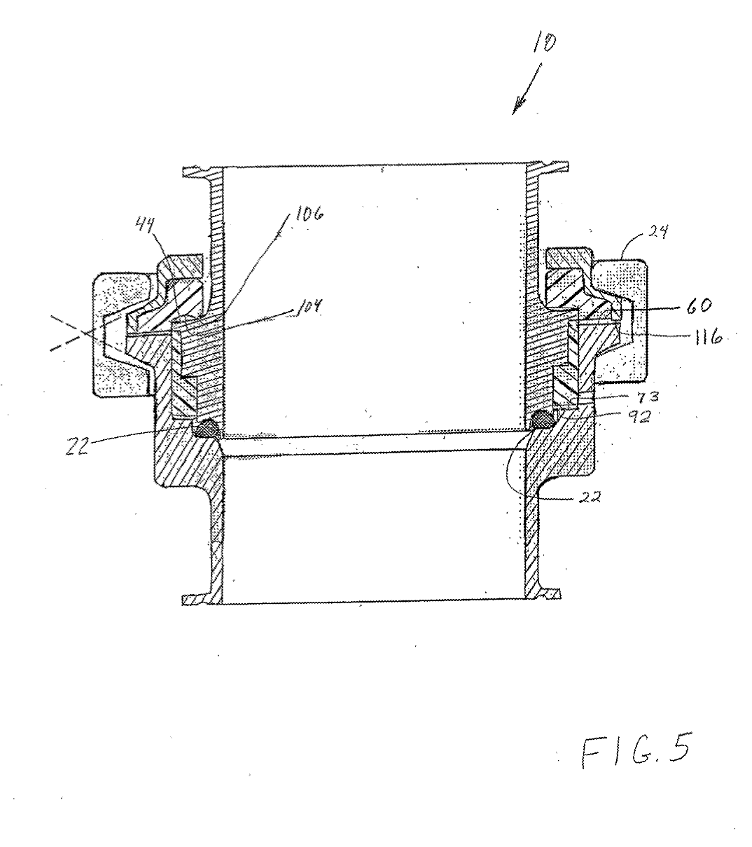

An upwardly-facing lower portion 120 of outer surface 112 of cap 16 is angled at an angle of about 15 degrees, optionally any angle between about 10 degrees and about 25 degrees from horizontal. Similarly, a downwardly-facing upper portion 122 of outer surface 66 of housing 12 is angled at an angle of about 5 degrees, optionally any angle between about 10 degrees and about 25 degrees from horizontal. Imaginary extensions of the angles of upper and lower portions 120 and 122 intersect each other as illustrated in FIG. 5.

Closure 24, illustrated as a clamp, has an outer-facing surface 124, an inner-facing surface 126, a top 128, and a bottom 130. Inner-facing surface 126 has a first angular portion 132 which generally conforms angularly to surface 120 of cap 16, a second angular portion 134 which generally conforms angularly to surface 122 of housing 12, and an upright surface 136 connecting outwardly-disposed ends of surfaces 132 and 134, and recessed away from both housing 12 and cap 16 in the rotatable joint assembly. Surfaces 132 and 134 are so spaced from each other that, when closure screw 144 is tightened, closure ring 145 is urged toward cap 16 and housing 12, and angular surfaces 132 and 134 of the closure bear on upper and lower portions 120 and 122, urging the cap and the housing toward each other, and correspondingly urging tube fitting 14 and housing 12 toward each other.

As closure 24 applies increasing force on the surfaces of upper and lower portions 120 and 122, housing 12 and tube fitting 14 are pushed increasingly closer to each other, thereby applying increasing pressure on seal 22, thus beginning to develop a leak-proof seal between housing 12 and tube fitting 14 at the o-ring. FIG. 4 illustrates the relative positioning of the elements of the joint as the pressure is being applied but before a complete seal has been achieved.

As closure 24 applies still more force, seal 22 is deformed into gap 75 as seen by comparing the right side of FIG. 4, where the seal is not yet deformed, and FIG. 5 where the seal is so deformed.

Seal surface 56 on the tube fitting defines a first magnitude of area of contact with seal 22 about the annulus defined by seal 22. Seal surface 74 on the housing defines a second magnitude of area of contact with seal 22 about the annulus defined by seal 22. As illustrated in e.g. FIGS. 4 and 5, the first area of contact of the tube fitting with the seal is greater than the second area of contact of the housing with the seal. The surface finishes of the seal surfaces 56 and 74, in the illustrated embodiments, are the same such that the static friction per unit area, between seal 22 and the respective seal surfaces 56 and 74, is the same for both seal surfaces. A typical such surface finish is about 32 Ra. Since the surface area of contact between the seal and the tube fitting is greater than the surface area of contact between the seal and the housing, and wherein the surface finishes are about the same, whereby static friction per unit area is the same, when tube fitting 14 rotates relative to housing 12, seal 22 preferentially rotates with the housing while remaining fixed, and not rotating, relative to tube fitting 14.

Above seal surface 74, inner surface 68 of the housing extends upwardly a short distance at a constant diameter, then extends outwardly at step 73, thence upwardly at a constant diameter along upper radial bearing surface 71 to upper end 60 of the housing. One or more leak detection ports 138 extend through upper portion 58 of the housing, from upper bearing surface 71 to ambient at outer surface 66, to provide an indication of any leakage of fluid past seal 22.

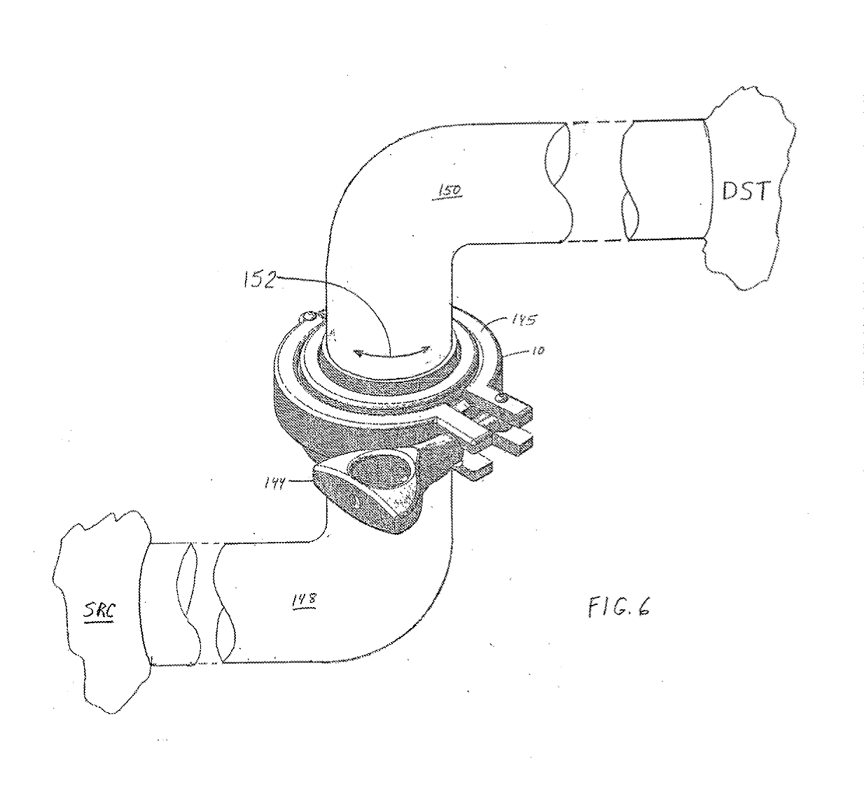

FIGS. 3-5 show an upper mating flange 140 on tube fitting 14 and a lower mating flange 142 on housing 12. FIGS. 1, 2, and 6 show no such flanges. Flanges 140, 142 are shown only to illustrate an alternative method of interfacing rotatable joint 10 with suitable fluid transfer piping. Such interfacing can be, for example and without limitation, flange connections as shown, or welding as suggested in FIG. 6, as well as other connectivity known in the art. When such flange 140 connection is provide at the upper end of tube fitting 14, cap 16 is installed on upper end 28 of the tube fitting and about outer surface 34, before flange 140 is added to the upper end of the tube fitting such as by welding.

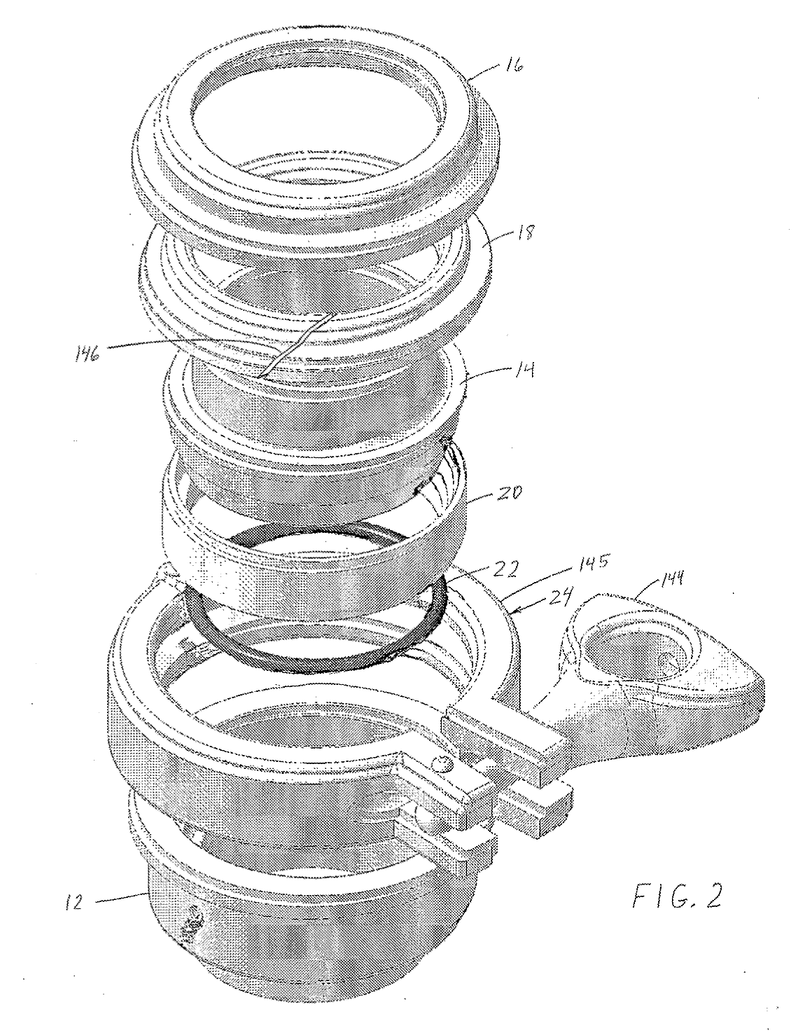

Cap bearing element 18, which is polymeric, and which thus does not tolerate the heat incident to welding, is assembled about outer surface 34, and under cap 16, after flange 140 has been fully formed and finished. To facilitate installing bearing element 18, bearing element 18 is cut through, top-to-bottom, as shown at a cut 146 in FIGS. 2 and 3. Cut 146 allows bearing element 18 to be resiliently expanded over larger circumference elements such as upper flange 140 and cap 16 when rotatable joint 10 is being assembled.

Housing 12, tube fitting 14, cap 16, and closure 24 are made of relatively harder, more dimensionally-stable food grade materials such as, for example and without limitation, stainless steel. Cap bearing element 18 and housing bearing element 20 are made of relatively softer, more resilient wear materials such as, for example and without limitation, polytetrafluoroethylene (PTFE) or polyetheretherketone (PEEK or polyvinylidene fluoride (PVDF)), all known as materials compatible for use in food processing, pharmaceutical processing, any process requiring a “clean-room” environment. Accordingly, wear in the rotatable joint is selectively focused on bearing elements 18, 20, and rubber seal 22, whereby wear in rotatable joint 10 can be accommodated by periodically, at appropriate intervals, replacing bearing elements 18, 20, and seal 22.

With rotatable joint 10 assembled as illustrated in FIGS. 1, 4, 5, and 6, tube fitting 14 and housing 12 can be rotated about common axis 78 relative to each other while seal 22 prevents leakage of fluid past seal cavity 76.

Housing bearing element 20 is mounted over tube fitting 14 on a diameter just above seal 22 and isolates the tube fitting 14 from housing 12, allowing tube fitting 14 to rotate about common longitudinal axis 78. Cap bearing element 18 is assembled over tube fitting 14 and is supported by flange 42. Flange 42 is located at a distance along longitudinal axis 78, abutting housing bearing element 20 with cap bearing element 18 abutting the opposite side of flange 42. Cap bearing element 18 is designed and assembled to cause minimal friction on tube fitting 14, thus allowing tube fitting 14 to rotate freely about longitudinal axis 78 relative to housing 12.

When fluid is passed through the assembled tube fitting and housing, seal 22 confines the fluid inwardly of fluid-contacting surfaces 38, 72, allowing no intrusion from outside atmosphere nor leakage of fluid past seal 22 to the outer surfaces of either tube fitting 14 or housing 12.

All inner surfaces, namely fluid-contacting surfaces 38, 72, in contact with any fluid, are aligned such that the fluid-contacting surfaces can be cleaned in place (CIP). Leak detection ports 138 in housing 12 serve to indicate when the seal has been compromised.

An outer portion of tube fitting 14 defines flange 42 which is adjacent bearing surface 50 of the tube fitting. Housing bearing element 20 is assembled over bearing surfaces 50 and 54, as well as over step 52, and abuts bottom surface 46 of flange 42. After bearing element 20 has been installed on tube fitting 14, seal 22 is installed on seal surface 56 of the tube fitting, just below lower bearing surface 92 of the bearing element. The outer diameter of seal 22, as installed at seal surface 56 on the tube fitting, is slightly greater than the outer diameter of bearing element 20 whereby seal 22 prevents bearing element 20 from sliding downwardly past seal 22. The respective sub-assembly of tube fitting 14, bearing element 20, and seal 22 is then installed into housing 12 until seal 22 abuts seal surface 74 in the housing. Cap bearing element 18 is then installed around tube fitting 14 and abutting top surface 44 of flange 42. Cap 16, if not previously installed, is then installed over the top of the tube fitting, downwardly toward flange 42, and into abutment with the top of cap bearing element 18. A closure, such as clamp 24, is then installed about the angled surfaces 120, 122 of cap 16 and housing 12 to secure the assembly as one unit. Pressure is applied urging housing 12 and tube fitting 14 toward each other as needed in order to drive seal 22 into gap 75.

The lateral displacement of the upper portion of fluid-contacting surface 72 of the housing from fluid contacting surface 78 at finger 57 creates a localized line of turbulence about the circumference of the joint at gap 75. Such localized turbulence helps in cleaning residual product from the area of gap 75 during a clean-in-place operation.

The distance between finger 57 and the top of fluid contacting surface 72, namely across gap 75, needs to be great enough to avoid contact between finger 57 and fluid contacting surface 72 during or after the process of assembling joint 10, while being small enough to discourage retention of residual product during a clean-in-place operation. A typical closest-approach dimension for gap 75 is about 0.015 inch, with a range of about 0.01 inch to about 0.04 inch, optionally about 0.015 inch to about 0.03 inch.

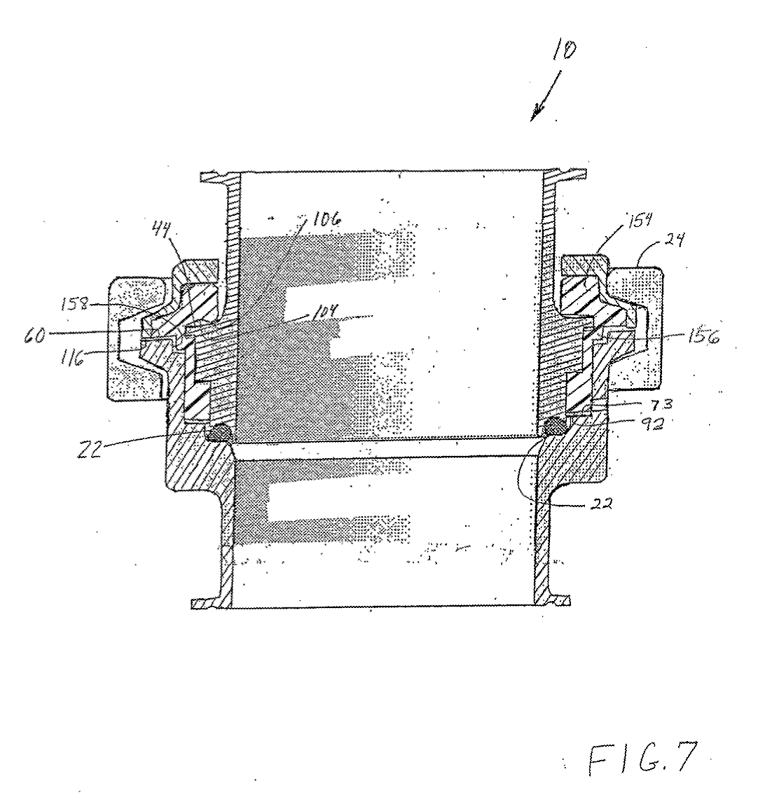

FIG. 7 illustrates use of a single, unitary, bearing structure 154 to provide bearing surfaces to both housing 12 and tube fitting 14. A cut 146 extends the full height of bearing structure 154 to facilitate assembly of the bearing structure to the tube fitting. Such bearing structure is assembled to tube fitting 14 before the tube fitting is assembled to housing 12. Bearing structure 146 has essentially the same structures and surfaces as bearing elements 18 and 20, with the addition of a bridge 156 connecting the structures of previous bearing elements 18 and 20. A corresponding recess 158 has been provided at upper end 60 of housing 12 to receive bridge 156.

As seen in e.g. FIGS. 1, 2, and 3, the illustrated closure 24 has first and second arms 160A, 160B, joined together at proximal ends of the respective arms such that the arms can pivot with respect to each other about a joint 162. Arms can pivot to either an open position, or a closed position. In the closed position, the remote ends of the arms approach each other, and the arms may be closed and clamped about the housing and the tube fitting, and secured by screw 144.

When closure 24 is opened to release the tube fitting and the housing from each other, the end of the screw remote from pivot pin 164 is pivoted about pivot pin 164 and away from housing 12. When the closure is to apply closing force to the joint, screw 144 is rotated about pivot pin 164 into the closing position shown in FIG. 1. With the screw in the closing position, the screw handle 166 is rotated with respect to threaded shaft 168 which is secured to pivot pin 164, pivot pin 164 being mounted for pivotation with respect to the remote end of arm 160A. Screw handle 166 extends through slot 170 in the remote end of arm 160B and bears on an end of arm 160B adjacent slot 170. As handle 166 is rotated, the handle is drawn by threaded shaft 168 toward pivot pin 164, thus drawing the remote ends of the arms together, and accordingly applying closing force on the closure; such closing force being transmitted to the housing and the cap. The degree of clamping force applied by closure 24 is controlled by the amount of force applied by screw 144 in advancing the closing action of closure 24. As illustrated in FIG. 1, even in the “closed” condition there is typically an open space 172 between the remote ends of the arms.

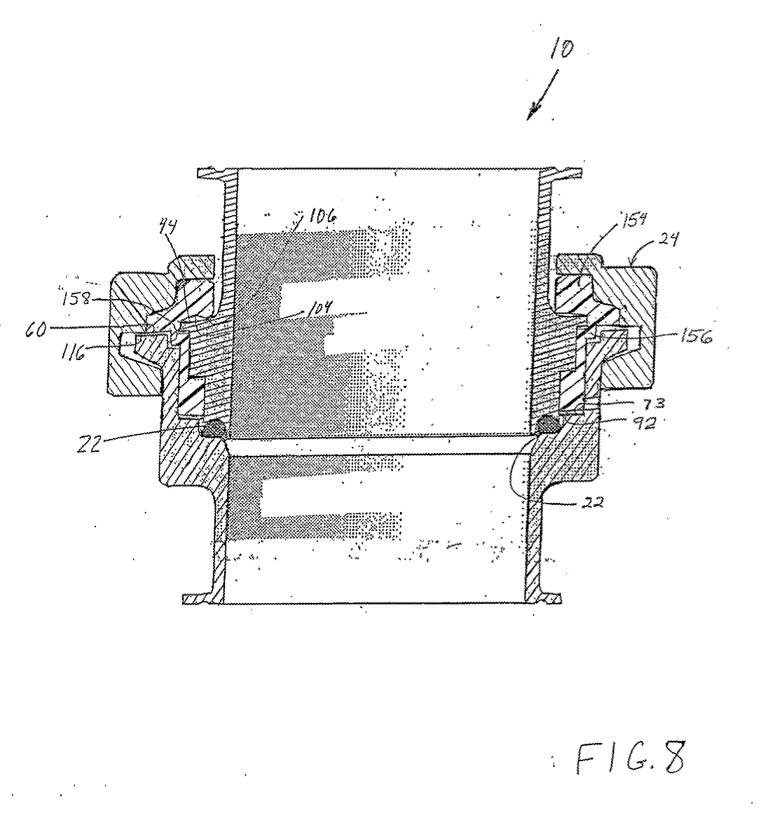

FIG. 8 illustrates yet another embodiment of the invention wherein the structure of the cap has been merged into closure 24. With the cap structure so merged into closure 24, the open space 172 extends to the structure which represents what was cap 16 in the other embodiments, thus extends entirely through the top-to-bottom height of the resulting closure 24. Accordingly, the resulting combined closure structure is mounted to the housing/tube fitting subassembly at the same time as the closure was mounted to the embodiments which include the cap as a separate element—whereby the cap structure and the closure structure, as a unitary structure, are mounted to the housing-tube fitting subassembly simultaneously as a single unitary structure.

For some applications, bolted flanges can be substituted in place of clamp-type closure 24.

Corrosion resistant balls or rollers can be used at any of the bearing points instead of sleeves.

Either of tube fitting 14 or housing 12 can serve as the rotating element of the rotatable joint while the other of tube fitting 14 or housing 12 serves as the stationary component. This is easily dictated based on how the rotatable joint is attached in the piping system.

### METHOD OF USE

The rotatable joint of the invention is typically used in a piping system which includes more than one fluid source “SRC” and/or more than one fluid destination “DST”, where fluid is transferred from multiple sources and/or to multiple destinations, or both. A typical such fluid transfer transfers fluid from a single source to a single destination at any given point in time. However, concurrent transfer from multiple sources is contemplated. Similarly, concurrent transfer to multiple destinations is contemplated, including concurrent withdrawal of fluid from multiple sources and concurrent delivery of such fluid to multiple destinations, optionally all passing through a single rotatable joint 10.

To use a rotatable joint of the invention, the lower end of housing 12 is connected to a first pipe 148 in the piping system and the upper end of tube fitting 14 is connected to a second pipe 150 in the piping system, as illustrated in FIG. 6, using the connection method of choice. FIG. 6 shows the pipes welded to the housing and tube fitting. Other connection methods such as clamping, threading, compression connectors and the like are known in the art. Once connected to the pipe or tube system, a fluid transfer process can be effected wherein fluid is withdrawn from one or more sources “SRC”, passes through one or more pipes and enters joint 10 through a first pipe such as pipe 148, passes through joint 10, and exits joint 10 from which the fluid passes into a second pipe such as pipe 150. The fluid then travels through pipe 150, optionally through additional piping, to one or more destinations “DST”. Once the fluid transfer has been completed, the piping system which was used for the just-completed fluid transfer, including joint 10, is cleaned in place to remove all residual product fluid. Then, one or more of the pipes is/are disconnected from one or more of the sources or destinations which have been connected to the piping system, and such pipe or pipes is/are re-directed, and connected, to a different source or sources, or different destination or destinations, in preparation for a subsequent fluid transfer. As the piping is re-directed, angular rotation of pipe 150 relative to pipe 148 is effected as needed at rotatable joint 10 as indicated by the double-headed arrow 152.

Referring again to FIG. 5, as tube fitting 14 rotates relative to housing 12, seal 22 maintains the leak proofness of joint 10; and polymeric bearing elements 18 and 20 provide sliding interfaces against which the metal of tube fitting 14 and housing 12 can slide as the housing and tube fitting move/rotate relative to each other, all as closure 24 maintains closing force urging the housing and tube fitting toward each other thus ensuring adequate force on seal 22 at cavity 76 to maintain a fluid-tight seal. The narrow width of edge 106 limits the magnitude of the sliding friction between bearing 18 and tube fitting 14.

Once the moved pipe or pipes have been connected to the different source or sources, and destination or destinations, a subsequent fluid transfer can be effected from a given source, through pipes 148, 150, through rotatable joint 10, to a given destination, wherein at least one of the sources and/or destinations is different from a source or destination used in the previous fluid transfer.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A rotatable joint, comprising:
(a) a housing, said housing having a first upper portion and a first upper end, a first lower portion and a first lower end, a first outer surface and a first inner surface, the first inner surface of said housing comprising a first fluid-contacting surface, a first inner-facing bearing surface, and a first seal surface;
(b) a tube fitting, said tube fitting having a second upper portion and a second upper end, a second lower portion and a second lower end, a second outer surface and a second inner surface, the second inner surface of said tube fitting comprising a second fluid-contacting surface, the second outer surface of said tube fitting comprising a second outer-facing bearing surface, said tube fitting being adapted and configured such that the second lower portion of said tube fitting is received inside said first upper portion of said housing, a second seal surface, which faces the first seal surface of said housing, being defined on the outer surface of said tube fitting, the first and second seal surfaces collectively defining a seal cavity, a flange extending outwardly and away from the second fluid-contacting surface and being spaced from the top of said tube fitting and from the bottom of said tube fitting, said flange having a top bearing surface;
(c) a cap extending about said tube fitting, and overlying the top surface of said flange, said cap having an outer surface and an inner surface;
(d) bearing structure comprising
(i) a first bearing element extending about said tube fitting, said first bearing element being disposed between the outer surface of said tube fitting and a portion of said cap, and bearing on the top bearing surface of said flange, and
(ii) a second bearing element below said flange and extending about said tube fitting, said second bearing element being disposed between the first inner-facing bearing surface of said housing and the second outer-facing bearing surface of said tube fitting;
(e) a seal in said seal cavity; and
(f) a closure urging said cap and said housing toward each other, thus applying sealing force against said seal in said seal cavity, thereby to provide a leak-proof seal effect between said housing and said tube fitting at the seal cavity while allowing for rotation of said housing and said tube fitting relative to each other.

2. A rotatable joint as in claim 1, said first and second bearing elements being spaced from each other.

3. A rotatable joint as in claim 1, further comprising a top-to-bottom cut (146) extending through said first bearing element and extending from a top of said bearing element to a bottom of said bearing element.

4. A rotatable joint as in claim 1, said housing and said tube fitting each having a circumference, said seal extending about the entirety of the respective circumferences of said housing and said tube fitting.

5. A rotatable joint as in claim 1, said second fluid-contacting surface of aid tube fitting extending from the top of said tube fitting to the bottom of said tube fitting.

6. A rotatable joint as in claim 1, said flange being above the seal cavity.

7. A rotatable joint as in claim 1, coefficients of friction of the first and second seal surfaces defining amounts of static friction whereby the static friction between one of
(i) said seal and said tube fitting, and
(ii) said seal and said housing,
is greater than the static friction between the other of
(iii) said seal and said tube fitting, and
(iv) said seal and said housing,
such that, when said tube fitting and said housing rotate relative to each other, said seal remains fixed, and rotates with one of said tube fitting and said housing, while moving relative to the other of said tube fitting and said housing.

8. A rotatable joint as in claim 1, said flange having a bottom bearing surface, and wherein, when said closure applies sufficient force that said flange meets a top surface of said second bearing element, said first bearing element remains spaced from the top of said housing at least until full sealing pressure has been applied at said seal.

9. A rotatable joint as in claim 1 wherein, when said closure urges said cap and said housing toward each other, a bottom of the second fluid-contacting surface approaches to within about 0.01 inch to about 0.04 inch of the first fluid-contacting surface.

10. A rotatable joint as in claim 1 wherein, when said closure urges said cap and said housing toward each other, a bottom of the second fluid-contacting surface approaches to within about 0.01 inch to about 0.03 inch of the first fluid-contacting surface.

11. A rotatable joint as in claim 1 wherein, when said closure urges said cap and said housing toward each other, a bottom of the second fluid-contacting surface approaches to within about 0.015 inch of the first fluid-contacting surface.

12. A rotatable joint as in claim 9, the bottom of the second fluid-contacting surface and the top of the first fluid-contacting surface defining a small gap therebetween, said seal extending into such small gap such that an inwardly-facing surface of said seal in said gap has a diameter about a circumference of said rotatable joint substantially no greater than the greater of a diameter of the first fluid-contacting surface or a diameter of the second fluid-contacting surface.

13. A rotatable joint as in claim 9, the bottom of the second fluid-contacting surface and the top of the first fluid-contacting surface defining a small gap therebetween, said seal being deformed into, and substantially filling, such gap.

14. A rotatable joint as in claim 9, the first fluid-contacting surface having a top and a bottom, further comprising a chamfer, expanding bottom-to-top, limited to an upper one-fourth portion of the first fluid-contacting surface and extending to the top of the first fluid-contacting surface.

15. A rotatable joint as in claim 1, said first bearing element defining a contacting edge having an edge width, and wherein the urging of said cap and said housing toward each other urges said first bearing element into downwardly-directed bearing contact with said tube fitting at or proximate the top bearing surface of said flange, such downwardly-directed bearing element contact at or proximate the top bearing surface being limited to essentially a one-dimensional linear contact limited by the width of the contacting edge.

16. A rotatable joint as in claim 1, said seal being disposed between said second be element and said first fluid-contacting surface.

17. A rotatable joint as in claim 1, the first fluid-contacting surface having a top, and wherein said seal is adjacent the top of said first fluid-contacting surface.

18. A rotatable joint as in claim 1, said second bearing element interfacing with the first inner-facing bearing surface of said housing and interfacing with the second outer-facing bearing surface of said tube fitting.

19. A rotatable joint as in claim 1, further comprising a leak detection port extending through said housing at a location displaced from said seal and between said seal and said upper end of said housing.

20. A rotatable joint as in claim 1 wherein said first seal surface faces generally downwardly and said second seal surface faces generally upwardly.

21. A rotatable joint as in claim 1 wherein said first and second bearing elements are embodied in a single unitary bearing structure.

22. A rotatable joint as in claim 21 wherein said single unitary bearing structure embodies a cut through said bearing structure and extending from a top of said bearing structure to a bottom of said bearing structure.

23. A piping assembly comprising first and second pipes, joined together by a rotatable joint of claim 1.

24. A piping assembly as in claim 23 wherein said piping assembly, including said rotatable joint, can be cleaned in place and thereby meet sanitary requirements for use of food-grade product in said piping assembly subsequent to such piping assembly having been cleaned in place.

25. A method of transferring fluid product comprising employing a piping assembly as in claim 24 wherein the piping assembly is cleaned after a such fluid product transfer without separating the rotatable joint from the piping assembly.

26. A rotatable joint, comprising:
(a) a housing, said housing having a first upper portion and a first upper end, a first lower portion and a first lower end, a first outer surface and a first inner surface, the first inner surface of said housing comprising a first fluid-contacting surface, a first inner-facing bearing surface, and a first seal surface;
(b) a tube fitting, said tube fitting having a second upper portion and a second upper end, a second lower portion and a second lower end, a second outer surface and a second inner surface, the second inner surface of said tube fitting comprising a second fluid-contacting surface, the second outer surface of said tube fitting comprising a second outer-facing bearing surface, said tube fitting being adapted and configured such that the second lower portion of said tube fitting is received inside said first upper portion of said housing, a second seal surface, which faces the first seal surface of said housing, being defined on the outer surface of said tube fitting, the first and second seal surfaces collectively defining a seal cavity, a flange extending outwardly and away from the second fluid-contacting surface and being spaced from the top of said tube fitting and from the bottom of said tube fitting, said flange having a top bearing surface;
(c) bearing structure extending about said tube fitting, a first portion of said bearing structure bearing on the top surface of said flange, a second portion of said bearing structure being disposed below said flange and extending about said tube fitting, said second portion of said bearing structure being disposed between the first inner-facing bearing surface and said housing and the second outer-facing bearing surface of said tube fitting;
(d) a seal in said cavity; and
(e) a closure extending about said housing and said tube fitting and overlying a top of said bearing structure over said flange, and urging said tube fitting and said housing toward each other, thus applying sealing force against said seal in said cavity, thereby to provide a leak-proof seal effect between said housing and said tube fitting at the seal cavity while allowing for rotation of said housing and said tube fitting relative to each other.

27. A rotatable joint as in claim 26, further comprising a top-to-bottom cut extending through said bearing structure from a top of said bearing structure to a bottom of said bearing structure.

28. A rotatable joint as in claim 26 wherein, when said closure urges said tube fitting and said housing toward each other, a bottom of the second fluid-contacting surface approaches to within about 0.01 inch to about 0.04 inch of the first fluid-contacting surface.

29. A rotatable joint as in claim 26, the bottom of the second fluid-contacting surface and the top of the first fluid-contacting surface thus defining a small gap therebetween, said seal being deformed into, and substantially filling, such gap.

30. A rotatable joint as in claim 28, the first fluid-contacting surface having a top and a bottom, further comprising a chamfer, expanding bottom-to-top, limited to an upper one-fourth portion of the first fluid-contacting surface and extending to the top of the first fluid-contacting surface.

31. A rotatable joint as in claim 26, said bearing structure interfacing with the first inner-facing surface of said housing and interfacing with the second outer-facing surface of said tube fitting.

32. A piping assembly comprising first and second pipes, joined together by a rotatable joint of claim 26.
